(19) United States
(12) Patent Application Publication
(10) Pub. No.: US 2002/0158900 A1
(43) Pub. Date: Oct. 31, 2002

(54) Graphical user interfaces for network management automated provisioning environment

(76) Inventors: Vivian G. Hsieh, Santa Clara, CA (US); Joshua Atir, Sunnyvale, CA (US)

Correspondence Address: James A. LaBarre, BURNS, DOANE, SWECKER & MATHIS, L.L.P., P.O. Box 1404, Alexandria, VA, 22313-1404, US

(21) Appl. No.: 09/843,768

(22) Filed: Apr. 30, 2001

(51) Int. Cl. G09G 5/00

(52) U.S. Cl. 345/738

(57) ABSTRACT

A graphical user interface for network management of devices associated with different customer infrastructures is described. The interface provides the user with a series of informational screens which rapidly provide the significant network configuration information which will be of interest to operations personnel. Additionally, graphical user interfaces according to the present invention provide techniques for rapid and repeatable installation and updating of operating system, application and customer software.

### FIELD OF THE INVENTION

The present invention is directed to graphical user interfaces generally and, more particularly, to graphical user interfaces which provide for the provisioning of servers and other computing devices that provide support for sites that are hosted on the Internet, intranets, and other communication networks.

### BACKGROUND THE INVENTION

The growing popularity and increasing accessibility of the Internet has resulted in its becoming a major source of information, as well as a vehicle for inter-party transactions, in a variety of environments. For instance, a number of different types of entities, such as government agencies, school systems and organized groups, host Internet and/or intranet web sites that provide informational content about themselves and topics related to their interests. Similarly, commercial enterprises employ web sites to disseminate information about their products or services, as well as conduct commercial transactions, such as the buying and selling of goods. To support these activities, each web site requires an infrastructure at one or more centralized locations that are connected to a communications network, such as the Internet. Basically, this infrastructure stores the informational content that is associated with a particular site, and responds to requests from end users at remote locations by transmitting specific portions of this content to the end users. The infrastructure may be responsible for conducting other types of transactions appropriate to the site as well, such as processing orders for merchandise that are submitted by the end users. A significant component of this infrastructure is a web server, namely a computer having software which enables it to receive user requests for information, retrieve that information from the appropriate sources, and provide it to the requestor. Web sites which provide more complex services, such as online ordering, may also include application servers to support these additional functions.

In the case of a relatively small entity, the infrastructure to support its web site may be as simple as a single server, or even a portion of a server. Conversely, a large, popular web site that contains a multitude of content and/or that is accessed quite frequently may require numerous web servers to provide the necessary support. Similarly, web sites for commercial entities, via which transactional operations are conducted, may employ multiple application servers to support transactions with a large number of customers at one time. In addition to servers, the infrastructure for a web site typically includes other types of computing devices such as routers, firewalls, load balancers and switches, to provide connectivity, security and efficient operation.

In addition to the hardware components associated with a web site's infrastructure, a number of software components are also typically involved therewith. The term “provisioning” is used herein to refer to, among other things, the installation of the software that is executed by the device to perform the functions assigned to it, and the subsequent configuration of that software to optimize its operation for the given site. Such provisioning initially occurs when the web site is launched, i.e. when one or more servers are connected to an appropriate communications network such as the Internet, and loaded with the programs and data content necessary to provide the services associated with the site. Thereafter, a need for further provisioning may arise, particularly in the case of a successful web site, when additional servers must be added to support an increasing number of requests from end users. In another instance, the provisioning of the servers and other computing devices may be required as part of a disaster recovery operation, for example a sudden interruption in power, an attack by a hacker, or corruption of stored software and/or data.

The provisioning of a server or other device that supports the operation of a web site involves several discrete steps. First, the appropriate operating system software must be loaded onto the device. Thereafter, software applications that are required to support the particular functions or services associated with the site are loaded, such as database software, credit card processing software, order processing software, etc. After they have been loaded, these applications may need to be configured, e.g. their operating parameters are set to specific values, to support the requirements of the particular site and/or optimize their performance for that site. Finally, the content associated with the individual pages of the web site must be loaded, after which further configuration may be required. The order in which these various components are loaded onto the server and configured can be quite critical, to ensure compatibility of the various programs with one another.

In the past, the hardware arrangements and interconnections, as well as the provisioning of web servers, was often carried out and annotated manually. In other words, each item of software was individually loaded onto the server and then configured by a person having responsibility for that task. The hardware interconnectivity was frequently ad hoc and occasionally poorly documented. One problem with such an approach is the fact that it consumes a significant amount of time. For a relatively large site that is supported by multiple servers, the provisioning could take several days to be completed, thereby delaying the time before the site can be launched and/or upwardly scaled to accommodate increasing traffic. Another, and perhaps more significant, limitation associated with the manual provisioning of devices is the lack of repeatability in the software configurations. More particularly, whenever manual operations are involved in the installation of software, there is always the possibility of human error, such as the failure to install one of the required components, or the loading of the various items of software in the wrong order. Such errors can result in misoperation or total failure of the web site, and can be extremely time consuming to discover and correct.

In addition, when a configuration adjustment is made on one device to improve its performance, if that change is not recorded by the person making the adjustment, it may not be carried over to subsequent devices of the same type when they are provisioned. This latter problem is particularly acute if a device should experience a failure a considerable period of time after the given device was configured. If the person who was responsible for originally configuring the device is no longer available, e.g. he or she has left the employ of the company hosting the site, it may not be possible to reconstruct the original configuration if it was not recorded at the time it was implemented. The same concerns arise if the site needs to be upwardly scaled by adding more devices of the same type after the employee has left.

To overcome some of the problems associated with the installation of software on multiple computers, various techniques have been developed which permit software to be automatically deployed to the computers with minimum involvement by humans. However, these techniques are limited in the types of environments in which they can be utilized. For example, in an enterprise where all of the users interact with the same legacy applications, a “cookie cutter” type of approach can be used to deploy the software. In this approach, every computer can have the same, standard set of programs, each with the same configuration. Once the software programs and settings have been determined, they can be packaged in a fixed format, sometimes referred to as a “ghost” or “brick”, and automatically disseminated to all of the appropriate computers. Thus, whenever a change is made to the standard configuration, it can be easily distributed to all of the users at once. Similarly, if a particular user experiences a failure, for instance due to a computer virus, the standard package can be readily installed on the user's computer, to restore the original functionality.

However, this type of automated deployment is not effective for situations in which computers, such as servers, need to be customized to accommodate the individual requirements of varied users. One example of such a situation is a data center which may house the infrastructure for hundreds of different web sites. The hardware and software requirements for these sites will typically vary among each site. For instance, each site will likely have a different business logic associated with it, i.e. the informational content and services associated with a given site will not be the same as those of any other site supported by that data center. These differences may require a combination of hardware and software which is unlike that of any other site. Similarly, different web site developers may employ different platforms for the sites, thereby necessitating various combinations of operating systems and application programs on the servers of the respective sites. Furthermore, different types of equipment may be utilized for the sites, thereby adding to the complexity of the provisioning process. In some cases, the same site may require a variety of different hardware devices, operating systems and application programs to handle all of the different services provided by that site. For an entity that is responsible for managing the varied infrastructure of these sites, such as a data center operator or a third-party infrastructure utility provider, the known approaches to automated software deployment are not adapted to meet the high degree of customization that prevails in these types of situations. Rather, because of the flexibility that is required to accommodate a different configuration of hardware and/or software for each site, manual provisioning is still being practiced to a large extent, with all of its attendant disadvantages.

An exemplary framework for the automated provisioning of servers and other devices that support various types of network-based services, such as the hosting of an Internet or intranet web site, is described in U.S. patent application Ser. No. 09/699,329, entitled “Automated Provisioning Framework For Internet Site Servers” to Raymond Suorsa, filed on Oct. 31, 2000. The present invention relates to graphical user interfaces which provide high level mechanisms by way of which the networking of devices disposed within an automated provisioning environment can be implemented in a repeatable and well-documented manner and which permits system operators to obtain, e.g., network configuration information, associated with the networking of provisioned infrastructures for a plurality of different customers.

### SUMMARY OF THE INVENTION

According to exemplary embodiments of the present invention, these and other drawbacks and limitations of conventional systems are overcome by graphical user interfaces for viewing and modifying networking information associated with devices in one or more data centers and associated with different customer infrastructures. Exemplary interfaces provide the user with a series of informational screens which rapidly provide the significant networking information which will be of interest to operations personnel.

According to one exemplary embodiment, a graphical user interface (GUI) according to the present invention includes a first user interface element actuable to access a first portion of said graphical user interface, which first portion displays information associated with a plurality of virtual local area networks (VLANs). The GUI provides various VLAN information and the ability for the user to modify some of this information, which modifications result in changes to a data model used to configure, monitor and operate the corresponding customer network infrastructures.

According to another exemplary embodiment of the present invention, a method of using such graphical user interfaces to, for example, rapidly allocate IP address space to selected VLANs is described.

These and other features of the invention are explained in greater detail hereinafter with reference to an exemplary embodiment of the invention illustrated in the accompanying drawings.

### BRIEF DESCRIPTION OF THE DRAWINGS

FIG. 1 is a block diagram of the basic logical tiers of a web site;

FIGS. 2a and 2b are more detailed diagrams of the devices in an exemplary web site;

FIG. 3 is a block diagram of one exemplary embodiment of the hardware configuration for a web site in a data center;

FIG. 4 is a general block diagram of a data center in which the infrastructures having devices that are viewed and configured using graphical user interfaces according to the present invention can be implemented;

FIG. 5 is a block diagram of an exemplary provisioning framework which interacts with graphical user interfaces in accordance with the principles of the invention;

FIG. 6 depicts a main menu of a graphical user interface according to an exemplary embodiment of the present invention;

FIGS. 7a and 7b depict portions of a graphical user interface for viewing data associated with the networking of devices in accordance with exemplary embodiments of the present invention;

FIGS. 8a-8c depict portions of a graphical user interface for viewing devices on a compartment-by-compartment basis in accordance with exemplary embodiments of the present invention;

FIGS. 9a-9b depict portions of a graphical user interface for flagging compartments in accordance with exemplary embodiments of the present invention;

FIGS. 10a-10g depict portions of a graphical user interface for managing virtual local area networks (VLANs) in accordance with exemplary embodiments of the present invention;

FIGS. 11a-11b depict portions of a graphical user interface for assigning compartments in accordance with exemplary embodiments of the present invention;

FIGS. 12a-12c depict portions of a graphical user interface for changing IP address space assigned to VLANs in accordance with exemplary embodiments of the present invention; and

FIGS. 13a-13b depict portions of a graphical user interface for creating a compartment in accordance with exemplary embodiments of the present invention.

### DETAILED DESCRIPTION

To facilitate an understanding of the principles of the present invention, it is described hereinafter with reference to its application in the provisioning of devices that support web site operations, such as servers, load balancers, firewalls, and the like. Further in this regard, such description is provided in the context of a data center, which typically accommodates the infrastructure to support a large number of different web sites, each of which may have a different configuration for its infrastructure. It will be appreciated, however, that the implementation of the invention that is described hereinafter is merely exemplary, and that the invention can find practical application in any environment where the automated provisioning of computer resources is desirable. Thus, for example, the principles which underlie the invention can be employed to provision computing devices in the networks of an enterprise, or in any other situation in which there are a sufficient number of computing devices to realize the benefits of automated provisioning.

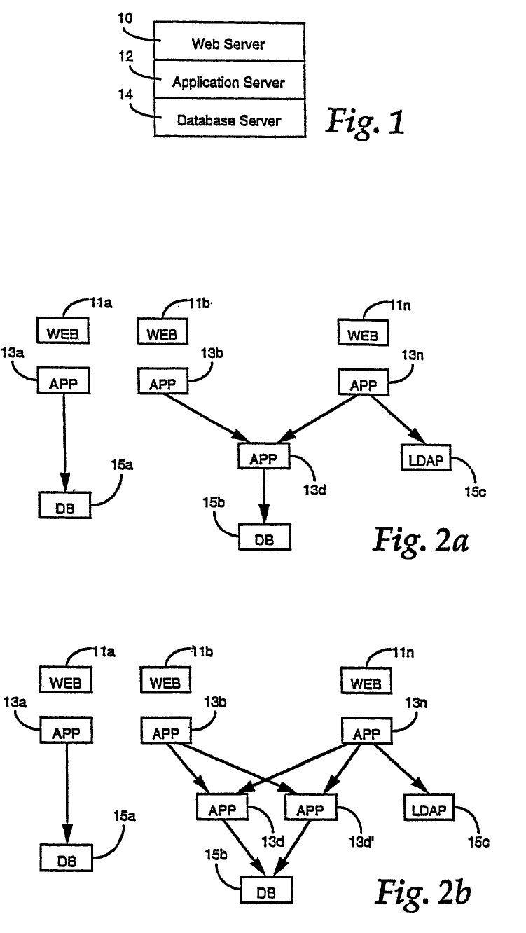

Prior to discussing the specific features of exemplary embodiments of the invention, a general overview of the infrastructure for hosting a web site will first be provided. Fundamentally, a web site can be viewed as consisting of three functional tiers. Referring to FIG. 1, one tier comprises a web server tier 10. The web server is the combination of hardware and software which enables browsers at end user locations to communicate with the web site. It performs the task of receiving requests from end users who have connected to the web site, such as HTTP requests and FTP requests, and delivering static or dynamic pages of content in response to these requests. It also handles secure communications through a Secure Socket Layer (SSL), and the generation of cookies that are downloaded to browsers. Typically, since these types of operations do not require a significant amount of processing power, the web server can operate at relatively high volume rates. The throughput capacity of this tier is usually determined by the amount of server memory and disk storage which is dedicated to these operations.

Another tier of the web site comprises an application server tier 12. This component performs dynamic transactions that are much more computationally intensive, such as order processing, credit card verification, etc. Typically, the application server implements the development environment that defines the business logic and presentation layer associated with a given site, i.e. its functionality as well as its “look and feel”. The performance of this tier is normally determined by the amount of CPU processing power that is dedicated to it. Separation of the web servers and the application servers into different tiers ensures reliability and scalability.

The third tier of the site comprises a database tier 14. This tier stores information relevant to the operation of the site, such as customer demographic and account information, available stock items, pricing, and the like. Preferably, it is implemented with a relational database architecture, to permit the data to be manipulated in a tabular form. Connection pooling to the database can be performed by the application servers, to minimize redundant calls and thereby preserve processing power.

While the fundamental architecture of a web site can be viewed as comprising these three tiers, in an actual implementation the structure of the web site can be significantly more complex. Depending upon the size and requirements of the site, in some cases the database tier can be combined into the application server tier. Even more likely, however, is an architecture in which one or more tiers is divided into several layers. This occurrence is particularly true for the application server tier, because it implements the business logic of a site. Depending upon the types of transactions to be performed by the site, the application server tier may require a number of different types of specialized application servers that are interconnected in various ways. One example of such is depicted in FIG. 2a. In this situation, the site includes a number of web servers 11a, 11b, . . . 11n. Each of these web servers may have the same software and same configuration parameters. The site also includes a number of application servers 13a, 13b, . . . 13n. In this case, however, not all of the application servers are the same. For instance, server 13a communicates with a first type of database server 15a, whereas servers 13b and 13n communicate with another application server 13d at a different level, which may be a highly specialized server. This server may communicate with a second type of database server 15b to carry out the specialized services that it provides. In addition, the server 13n may communicate with a directory server 15c.

If the performance of the server 13d begins to degrade due to increased traffic at the web site, it may be necessary to add another server 13d′, to provide additional CPU capacity, as depicted in FIG. 2b. However, because of the architecture of the site, the automated provisioning task becomes more complex, since the application server 13d is different from the other application servers 13a, 13b, etc., in both its configuration and its connection to other devices. Hence, not all of the application servers can be treated in the same manner. Furthermore, since the business logic of a given site is likely to be different from that of other sites, the configuration parameters that are employed for the site of FIG. 2a may not be appropriate for the devices of any other site, which increases the complexity of the provisioning process even more.

In many instances, the infrastructure for supporting a web site is housed in a data center, which comprises one or more buildings that are filled with hundreds or thousands of servers and associated equipment, for hosting a large number of different web sites. Typically, each floor of the data center contains numerous rows of racks, each of which accommodate a number of servers. In one configuration, each web site may be assigned a portion of a server, or portions of several servers, depending upon its requirements. This approach is typically employed by Internet service providers (ISPs), and is referred to as a “multitenancy” configuration, wherein multiple sites may be resident on a given server.

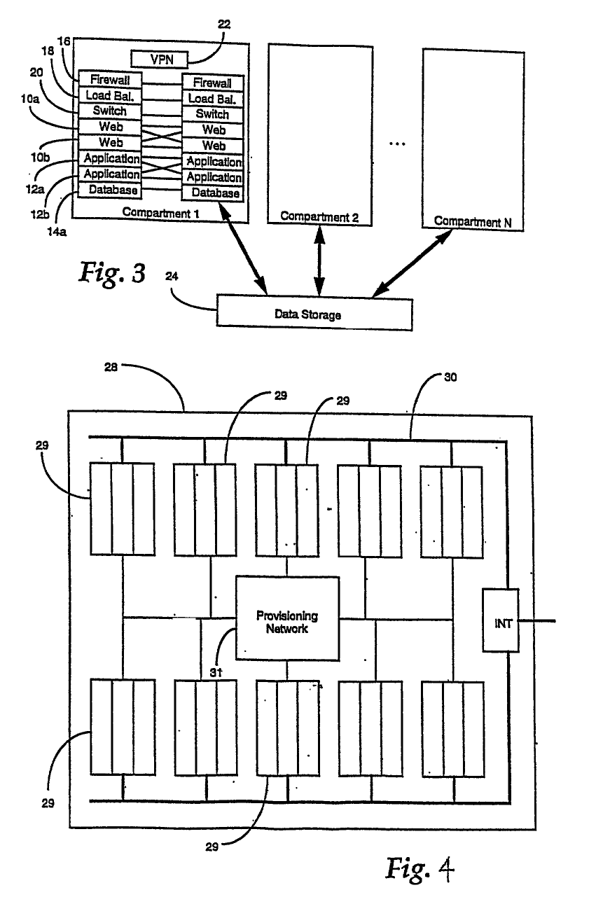

In an alternate configuration, each site is allocated a discrete compartment within the data center, with the servers and other computing devices within that compartment being dedicated to hosting the services of the given site. FIG. 3 is a block diagram illustrating this latter configuration. This figures illustrates three exemplary web site compartments, each of which accommodates the equipment for hosting a web site. Thus, in the illustrated embodiment, each compartment includes one or more web servers 10a, 10b, one or more application servers 12a, 12b, and a database server 14a, to provide the three functional tiers. In addition, the components of the web site infrastructure may include a firewall 16 to provide security against attacks on the site, a load balancer 18 for efficient utilization of the web servers and the application servers, and a switch 20 for directing incoming data packets to the appropriate servers. These devices in the web site compartment can be securely connected to the host entity's computer system via a virtual private network 22. To avoid a single point of failure in the web site, additional redundant components are included, and like components are cross-connected with one another. This feature of redundancy and cross-connection adds another layer of complexity to the automated provisioning process, particularly as the web site grows so that the number of devices and their cross-connections increase and become more complicated to manage.

The physical storage devices for storing the data of a web site can also be located in the compartment, and be dedicated to that site. In some cases, however, for purposes of efficiency and scalability, it may be preferable to share the data storage requirements of multiple compartments among one another. For this purpose, a high capacity storage device 24 can be provided external to the individual compartments. When such a configuration is employed, the storage device 24 must be capable of reliably segregating the data associated with one compartment from the data associated with another compartment, so that the different hosts of the web sites cannot obtain access to each others' data. Examples of storage devices which meet these requirements are those provided by EMC Corporation of Hopkinton, Mass. For additional discussion of the manner in which devices of this type can be incorporated into an infrastructure such as that depicted in FIG. 3, reference is made to U.S. patent application Ser. No. 09/699,351, filed on Oct. 31, 2000, entitled “A Data Model For Use In The Automated Provisioning of Central Data Storage Devices”, the disclosure of which is incorporated herein by reference.

One feature of the present invention comprises graphical user interfaces and methods associated with the use of such interfaces for automating the network management of devices employed in various customer's infrastructures, e.g., monitoring IP address spaces associated with such devices. Further in this regard, an objective of the invention is to provide graphical user interfaces for deploying and networking together a large number of servers and associated devices within one or more data centers, that may be associated with different respective web sites, and therefore have different provisioning and interconnectivity requirements.

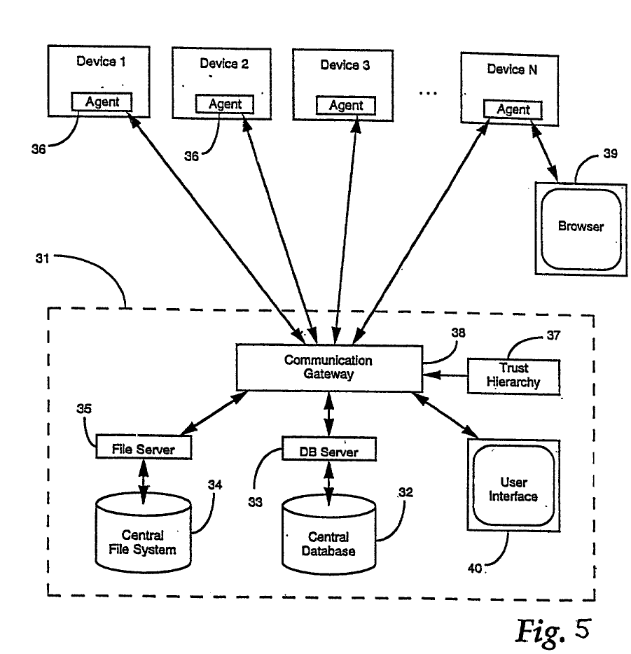

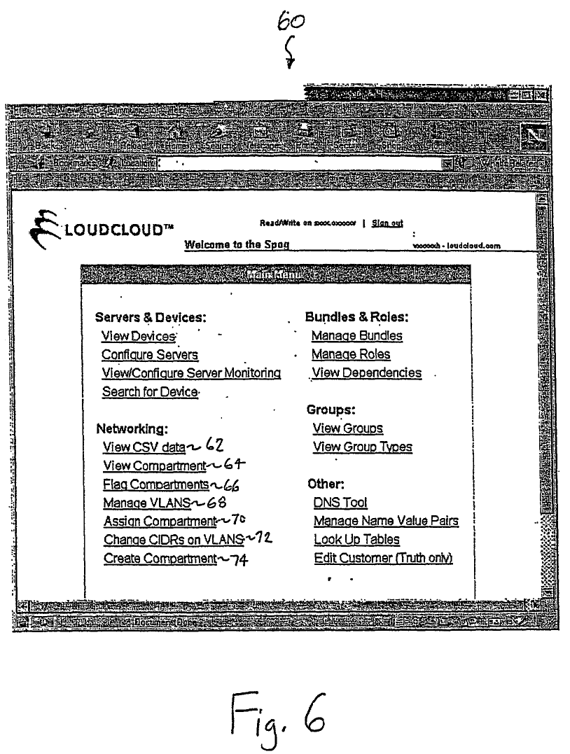

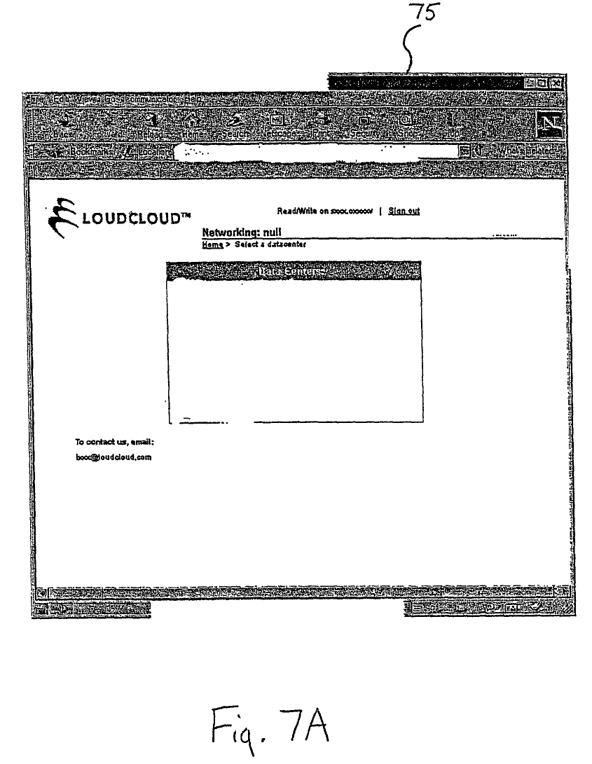

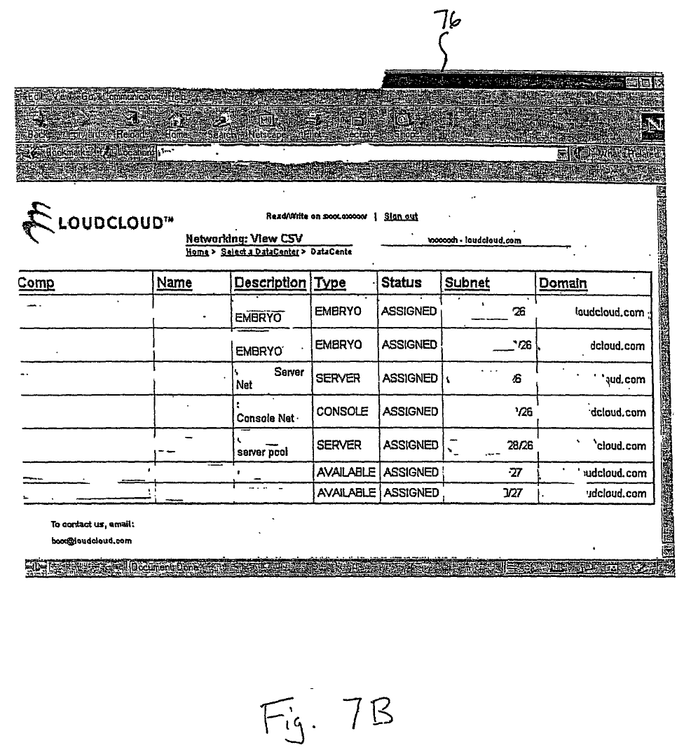

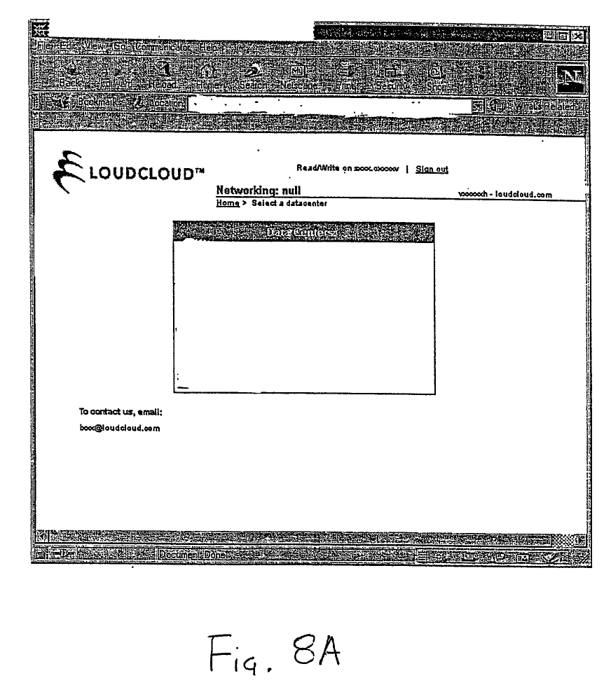

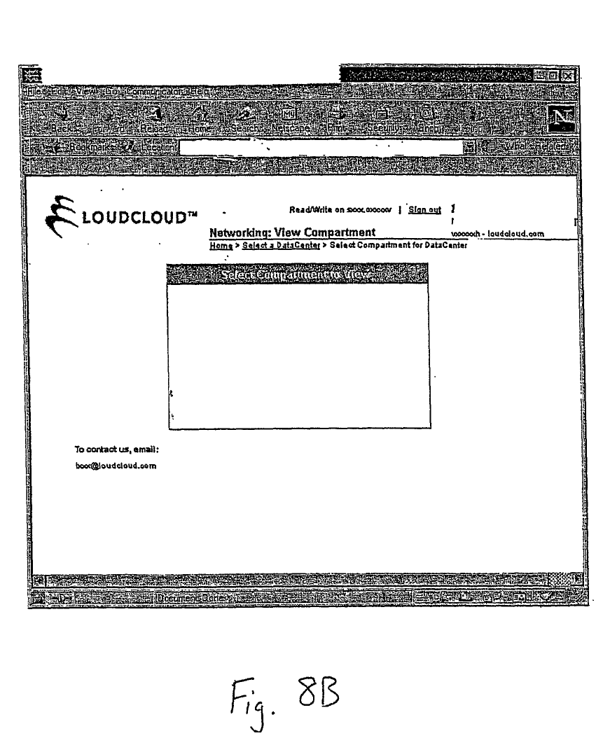

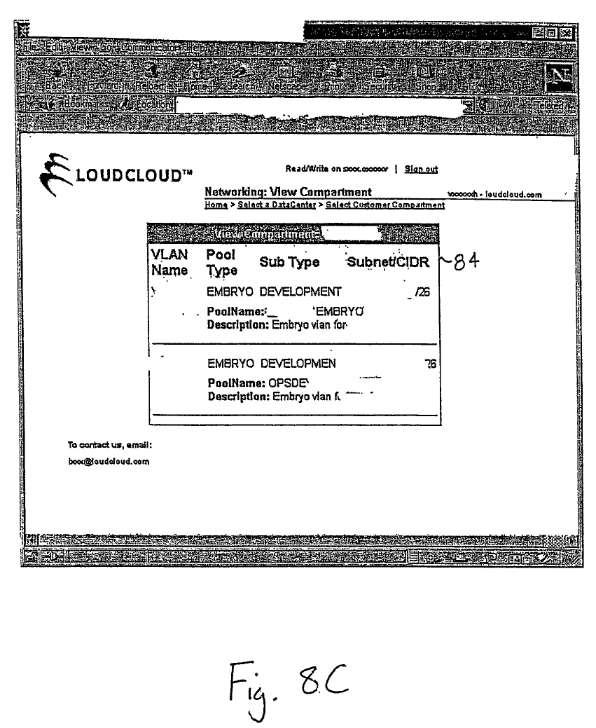

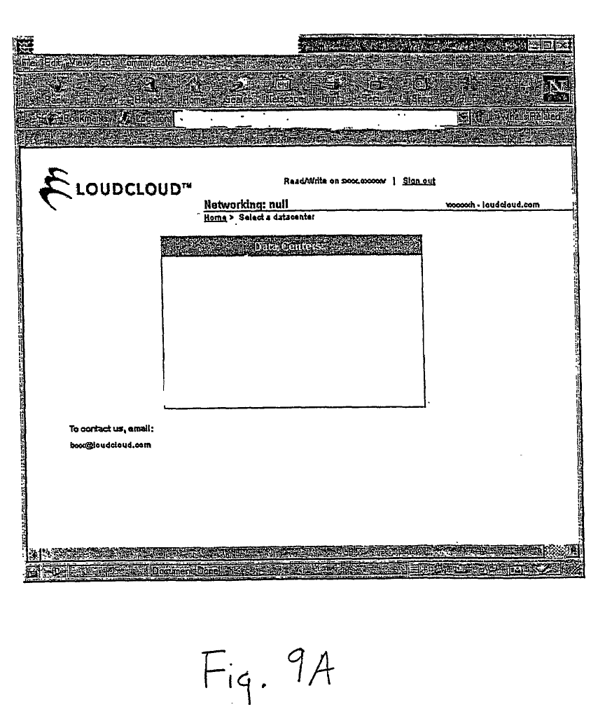

An overview of one environment in which the present invention operates is depicted in FIG. 4. A data center 28 is partitioned into multiple customer compartments 29, each of which may be arranged as shown in FIG. 3. Each compartment is connected to a backbone 30 or similar type of common communication line for access by computers which are external to the data center. For instance, if the compartments are associated with Internet web sites, the backbone 30 constitutes the physical communication path via which end users access those sites over the Internet. The backbone may also form the path via which the web site hosts can securely communicate with the devices in their individual compartments, for instance by virtual private networks.

Also located in the data center 28 is a provisioning and management network 31. This network may be located within another compartment in the data center. This network is connected to the computing devices in each of the compartments 29 which are to be managed. In the embodiment of FIG. 4, the provisioning network 31 is illustrated as being connected to the compartments 29 by a network which is separate from the backbone 30. In an alternative implementation, the provisioning network can communicate with the compartments over the backbone, using a secure communications protocol.

The provisioning network 31 may be operated by the owner of the data center, or by a third-party infrastructure utility provider. While FIG. 4 illustrates all of the compartments being connected to the network 31, this need not be the case. To this end, multiple provisioning networks may be located in the data center, with each one operated by a separate entity to provision and manage the devices in different ones of the compartments 29.

To automate the provisioning of servers and related types of devices in accordance with this exemplary provisioning framework, an agent can be installed on each device that is controlled by the network 31, to handle the retrieval and loading of software onto the device. The agent communicates with the provisioning network 31 to obtain commands regarding tasks that need to be performed on its device, as well as obtain the software components that are to be installed as part of the provisioning process. For more details regarding exemplary agents and their operation in automated provisioning systems, the interested reader is referred to U.S. patent application Ser. No. 09/699,354, filed on Oct. 31, 2000, entitled “Automated Provisioning Framework for Internet Site Servers”, the disclosure of which is incorporated here by reference.

One example of a provisioning network 31 that communicates with the agents on individual devices, to perform automated provisioning, is illustrated in FIG. 5. Two fundamental functions are implemented by the provisioning network. One of these functions is to maintain information about, and manage, all of the devices that are associated with the provisioning system. The second function is to store and provide the software that is loaded on these devices. The first function is implemented by means of a central database 32, that is accessed via a database server 33. This database comprises a repository of all pertinent information about each of the devices that are connected to the provisioning network. Hence, depending upon the extent of the provisioning system, the central database might contain information about devices in only a few web site compartments, or an entire data center, or multiple data centers. The information stored in this database comprises all data that is necessary to provision a device. For instance, it can include the hardware configuration of the device, e.g., type of processor, amount of memory, interface cards, and the like, the software components that are installed on the device along with the necessary configuration of each of those components, and logical information regarding the device, such as its IP address, the web site with which it is associated, services that it performs, etc. For a detailed discussion of an exemplary model of such a database for storing all of the relevant information, reference is made to U.S. patent application Ser. No. 09/699,353, filed on Oct. 31, 2000, the disclosure of which is incorporated herein by reference. In essence, the information stored in the database constitutes a model for each device that is managed by the provisioning system, as well as the interconnection of those devices.

The second principal function of the provisioning network is implemented by means of a central file system 34, which is accessed via a file server 35. This file system stores the software that is to be installed on any of the devices under the control of the provisioning system. To facilitate the retrieval of a given item of software and forwarding it to a destination device, the software components are preferably stored within the file system as packages. One example of a tool that can be used to create software packages for a Linux operating system is the Red Hat Package Manager (RPM). This tool creates packages in a format that enables the contents of a package, e.g. the files which constitute a given program, to be readily determined. It also includes information that enables the integrity of the package to be readily verified and that facilitates the installation of the package, i.e., by including installation instructions that are built in to the RPM package. To support a different operating system, a packaging tool appropriate to that operating system, such as Solaris Packages for Sun operating systems or MSI for Microsoft operating systems, can also be employed. Regardless, all packages for all operating systems can be stored in the file system 34.

In operation, when the automated provisioning of a device is to be performed, a command is sent to an agent 36 on the device, instructing it to obtain and install the appropriate software. The particular software components to be installed are determined from data stored in the central database 32, and identified in the form of a Uniform Resource Location (URL), such as the address of a specific package in the file system 34. Upon receiving the address of the appropriate software, the agent 36 communicates with the central file system 34 to retrieve the required packages, and then installs the files in these packages onto its device. The commands that are sent to the agent also instruct it to configure the software in a particular manner after it has been loaded. Commands can also be sent to the agent to instruct it to remove certain software, to configure the network portion of the operating system, or to switch from a dynamically assigned network address to one which is static. To further enhance the security of the communications between the provisioning network and the agents, the network includes a central gateway 38 for communications.

There may be situations in which it is desirable to permit personnel who do not have access to the provisioning system per se to communicate with the agents. For instance, IT personnel at the entity hosting the site may need to perform some types of operations through the agent. In this case, the agent can be given the ability to communicate with a computer 39 external to the network, for instance by means of a browser on that computer. This external access can also serve as a debugging mechanism. For instance, a new configuration can be set up on a device and then tested in isolation on that device, via the browser, before it is deployed to all of the other devices of that same type. Whenever access to a device is sought by an entity outside of the secure network 28, the agent communicates with the gateway 38 to check with the trust hierarchy 37 and first confirm that the entity has the authority to access the device.

Another component of the provisioning system is a user interface 40 by which the devices are managed. The user interface 40 communicates with the gateway 38, which converts messages into the appropriate format. For instance, the gateway can convert SQL data messages from the database 32 into an XML (Extensible Markup Language) format which the user interface 40 then processes into a presentation format for display to the user. Conversely, the gateway converts procedure calls from the user interface into the appropriate SQL statements to retrieve and or modify data in the database 32. For a detailed description of one technique for performing such a conversion, reference is made to U.S. patent application Ser. No. 09/699,349, filed on Oct. 31, 2000, entitled “Object Oriented Database Abstraction and Statement Generation”, the disclosure of which is incorporated herein by reference.

In essence, the user interface 40 comprises a single point of entry for establishing the policies related to the management of the devices. More particularly, whenever a change is to be implemented in any of the devices, the device is not directly configured by an operator. Rather, through the user interface, the operator first modifies the model for that device which is stored in the database. Once the model has been modified, the changes are then deployed to the agents for each of the individual devices of that type from the data stored in the database, by means of the gateway 38. Preferably, the version history of the model is stored as well, so that if the new model does not turn out to operate properly, the device can be returned to a previous configuration that was known to be functional. The different versions of the model can each be stored as a complete set of data, or more simply as the changes which were made relative to the previous version.

An exemplary user interface according to the present invention will now be described with respect to FIGS. 6-13. In FIG. 6, a main menu screen 60 associated with the user interface 40 is illustrated. Although this exemplary embodiment of a graphical user interface (GUI) according to the present invention is described in the context of a hierarchical, menu style GUI, those skilled in the art will appreciate that other user interface techniques could also be used to provide the same interface functionality. Therein, a plurality of links are provided for the user's selection to perform various interactions with the provisioning system, e.g., that described above, and/or to gather information associated with the provisioning system and the provisioned infrastructure. Although a user can select any of the illustrated links, in any order to access the lower hierarchical menus, this description will discuss the linked screens, and their associated functionality, in the order listed in FIG. 6. Since the present invention is primarily concerned with graphical user interfaces for networking devices in an automated provisioning system, only the GUI portions associated with links 62-74 are described in detail herein. Those readers interested in other graphical user interfaces associated with automated provisioning environments are directed to U.S. patent application Ser. No.______. entitled “Graphical User Interface for Viewing and Configuring Devices in an Automated Provisioning Environment”, filed on an even date herewith (Attorney Dkt. No. 033048-013) and U.S. patent application Ser. No.______. entitled “Graphical User Interface for Software Management in an Automated Provisioning Environment”, filed on an even date herewith (Attorney Dkt. No. 033048-048), the disclosures of which are incorporated here by reference.

A user selecting the “View CSV data” link 62 at the main menu 60, e.g., by moving a cursor over the link and clicking thereon, can access the “Select a Data Center” menu screen 75 depicted in FIG. 7A. Note that therein, and in subsequent screen shots of an exemplary graphical user interface according to the present invention, various alphanumeric information is blacked out to avoid disclosure of confidential, e.g., customer, information. The blacked out alphanumeric information is not, however, significant to the functionality of the exemplary user interface itself, which functionality is described and claimed herein.

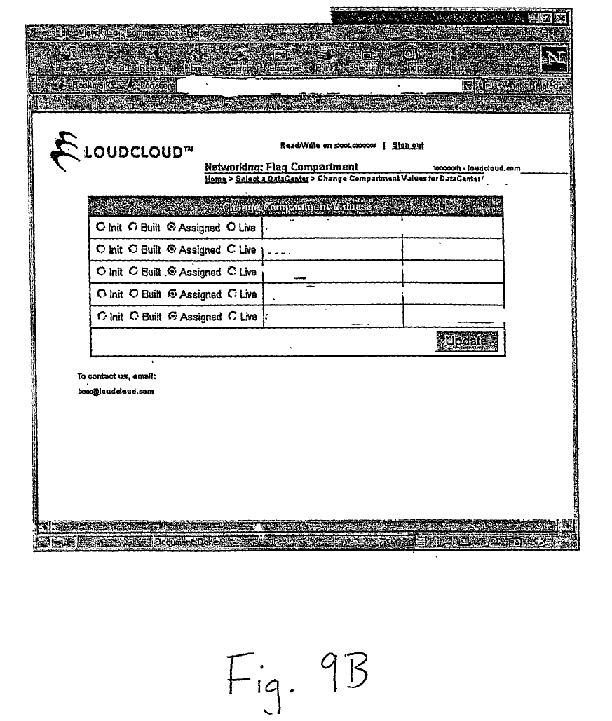

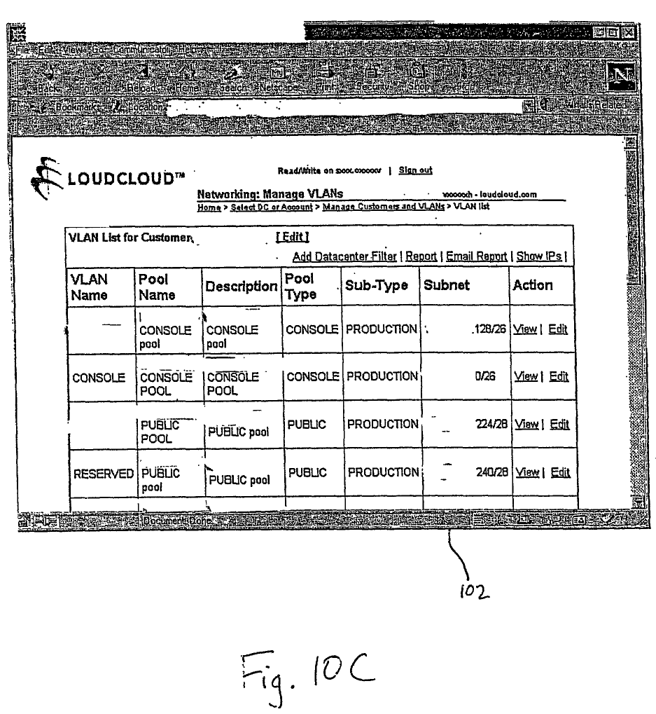

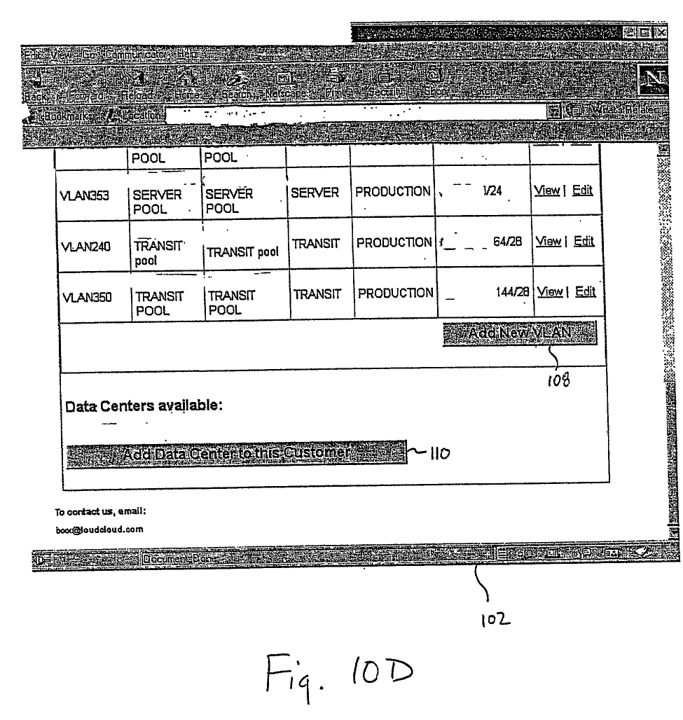

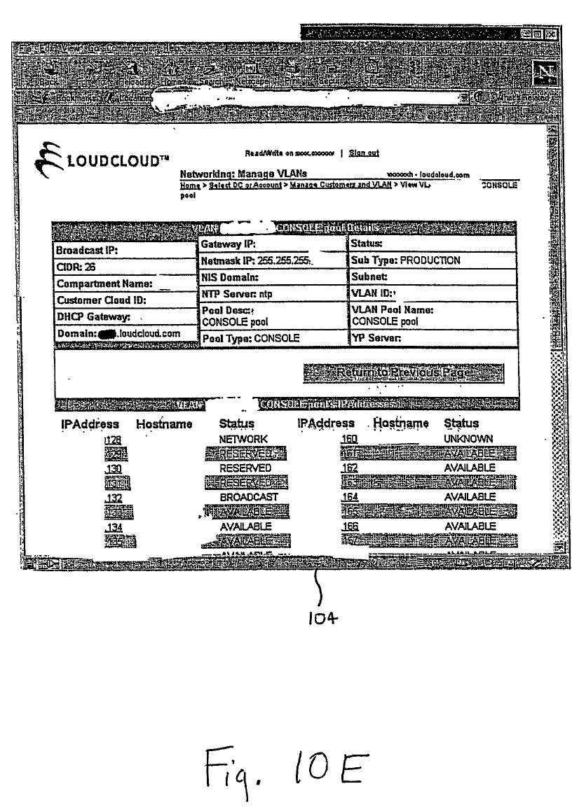

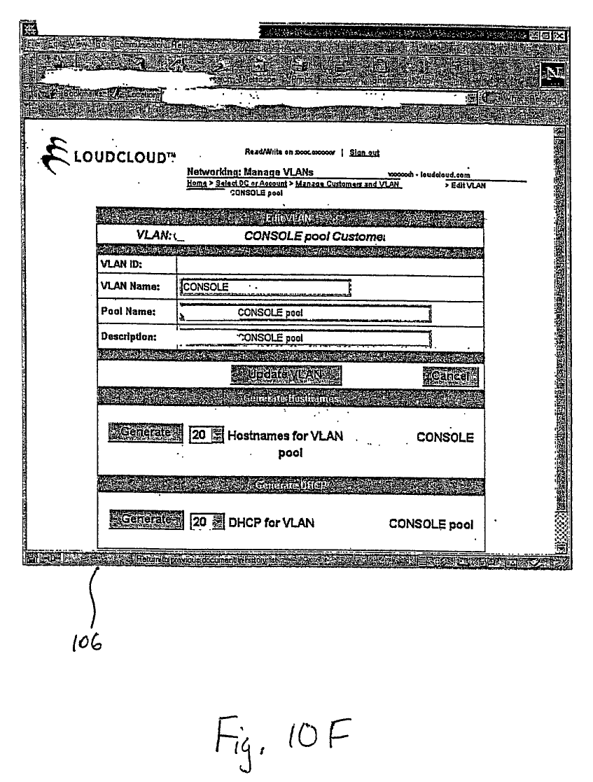

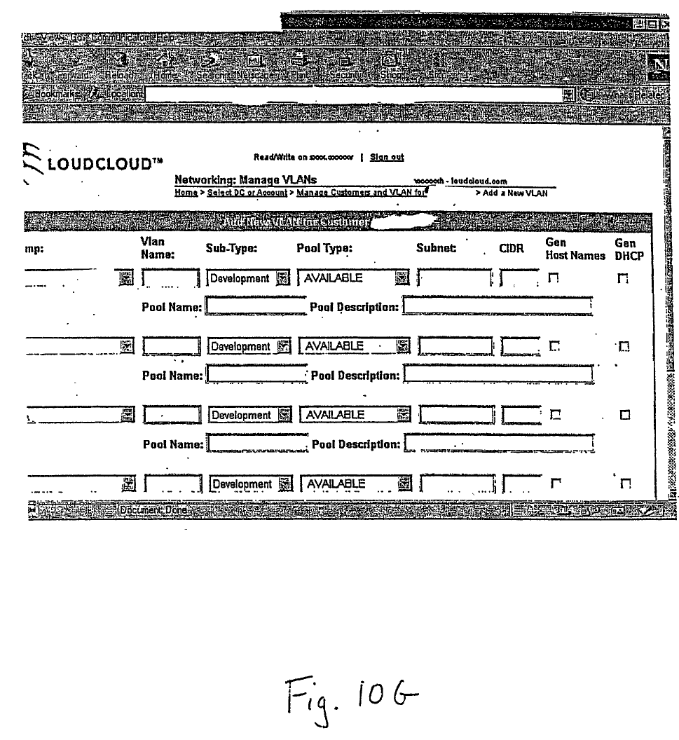

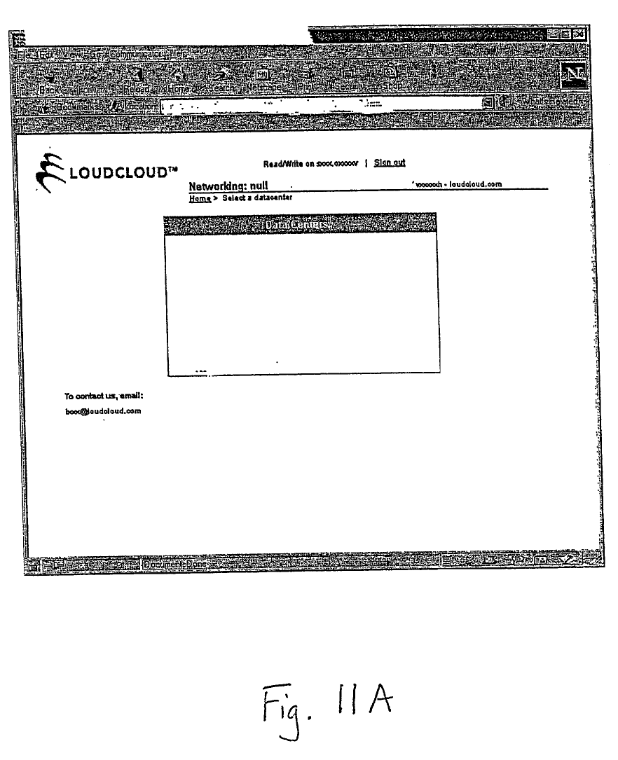

The CSV (an acronym which refers to “comma separated value”) data portion of graphical user interfaces according to the present invention provides users with an opportunity to view different sets of network configuration data associated with devices being managed by the provisioning system 31. Having selected a data center from the menu of FIG. 7A, a GUI display 76 is then generated which lists the various customer compartments which are present within the selected data center, as exemplified by FIG. 7B. Although the example of FIG. 7B lists only seven compartments, those skilled in the art will appreciate that a typical data center will usually include many more such compartments. Therein, for each VLAN (an acronym for “Virtual Local Area Network”, described in more detail below), the customer compartment name, the VLAN name, a text description of the VLAN, the VLAN type, the VLAN status, a subnet associated with the VLAN and the VLAN's domain are identified in respective fields which are populated from the data model in database 32. Each customer may have its devices physically stored in a rack and/or cage within one or more compartments within the data center, thus the compartment name provides the network engineer with a general idea of the physical location of a particular VLAN displayed in screen 76. The description field provides an area within which a freeform or autogenerated textual description of the VLAN can be appended. The type field may take on one of a plurality of values, e.g., server pool, public pool, embryo pool, which indicate the function and/or accessibility of the VLAN. The subnet field identifies the IP address range for each VLAN, while the domain field provides the broadcast domain value for each VLAN. From the “View CSV” data screen 76, the user can, in this exemplary embodiment, also jump to either the “View Compartment” screen 84 (exemplified by FIG. 8C) for more detailed information about a compartment of interest or to a detailed VLAN screen (e.g., as in FIG. 10E) for more information about a VLAN of interest.

Returning to the main menu of FIG. 6, the next link available to the user is the “View Compartment” link 64. Actuating this link permits the user to view networking data on a customer compartment basis, rather than on a VLAN basis. Again, the user can reach a particular compartment of interest by first selecting a data center of interest (FIG. 8A), followed by the compartment of interest (FIG. 8B). This results in the detailed network connectivity information screen 84 of FIG. 8C, for example, being displayed. This series of GUI displays provides the network engineer with a shortcut to a particular compartment's networking information.

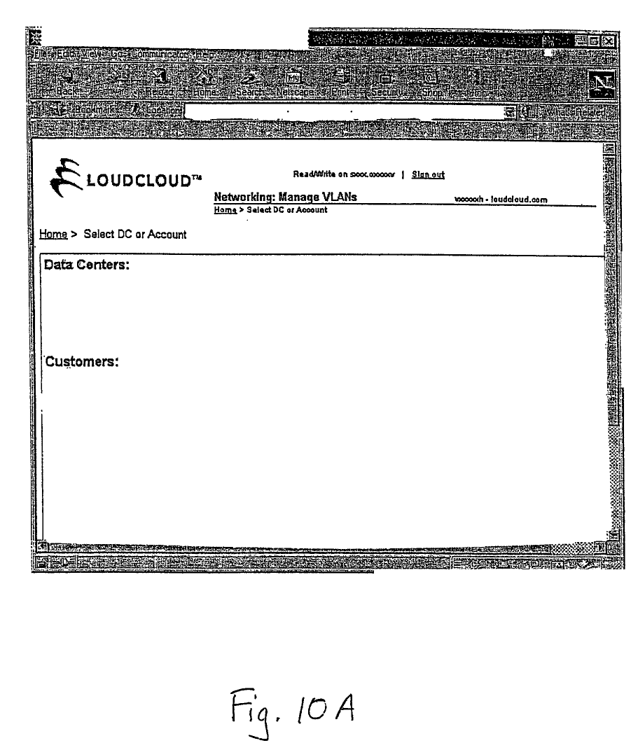

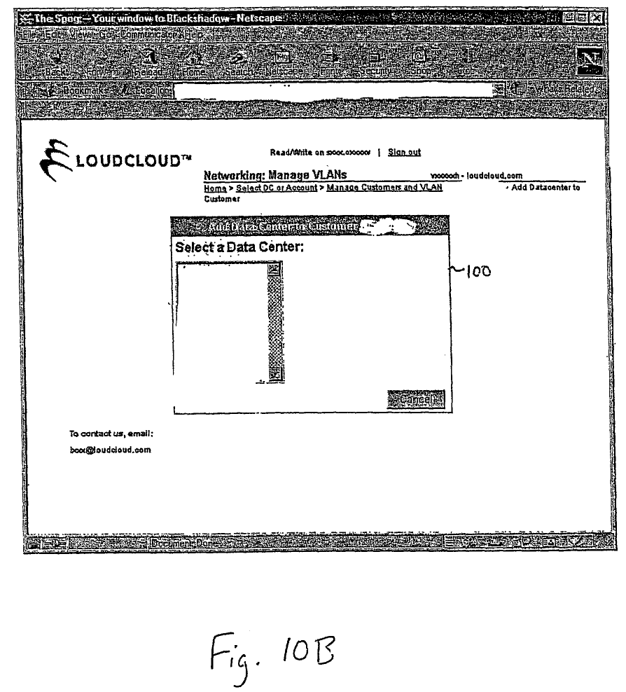

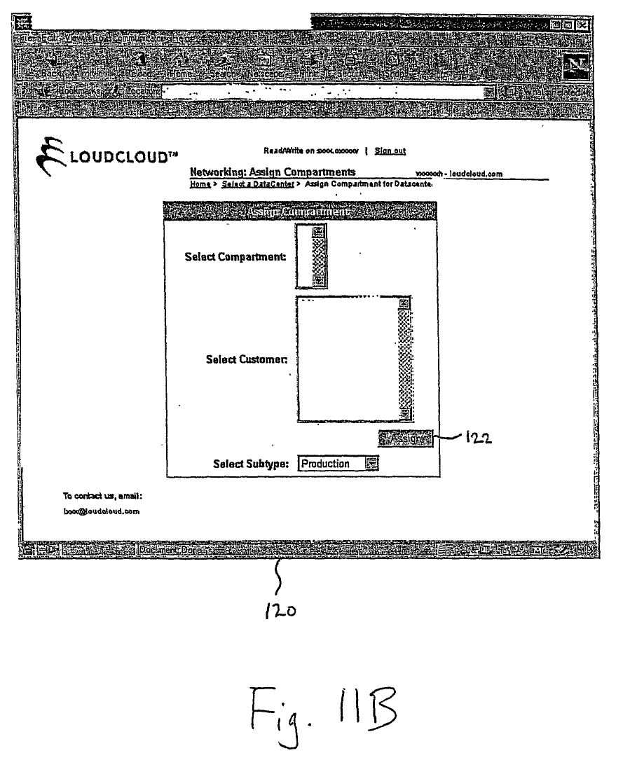

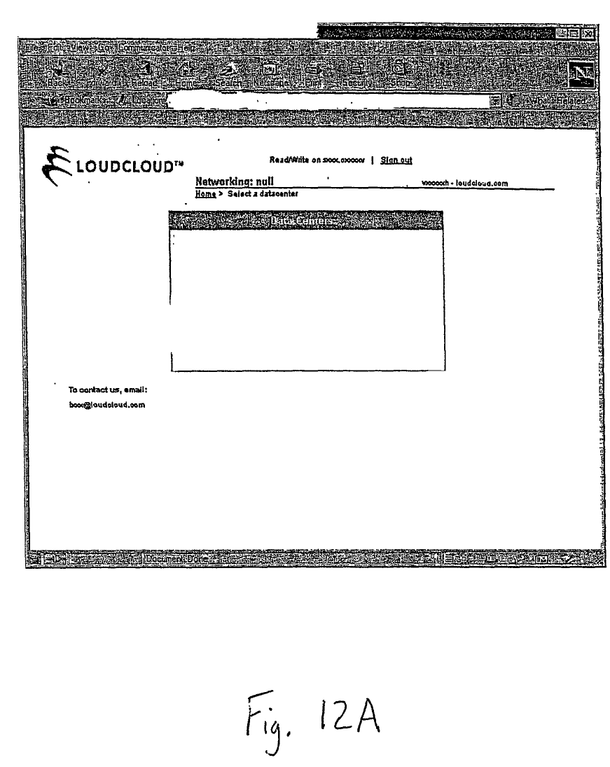

In some exemplary embodiments of the present invention, data centers may be mapped out logically, i.e., customer compartments may be allocated to a data center prior to physically acquiring the customer or racking devices in a customer compartment. In such exemplary embodiments, it may be useful for network engineers to change the status of a compartment as it is registered with the provisioning system 31. Thus, if a user actuates the “Flag Compartment” link 66 of FIG. 6, this leads, once again, to a data center selection screen as depicted in FIG. 9A. Once a data center is selected, the user is provided with a mechanism for changing compartment values for that data center, e.g., as shown in FIG. 9B. Therein, a compartment may take on of the exemplary values of “init”, “built”, “assigned” and “live”. The second and third columns can provide alphanumeric descriptions of the compartment name and customer name, respectively. The “init” value refers to a compartment that is completely virtual, e.g., it has been laid out on paper within the data center and, possibly, assigned an IP address range, but has not yet been physically built. The “built” value means that the compartment physically exists within the data center and that one or more customers can be assigned thereto, but it does not yet have live devices residing therein that requirement monitoring or other servicing by the provisioning network 31. Once a compartment has been designated as “built”, customers can then be assigned thereto, e.g, using the “Assign Compartment” link 70 of FIG. 6 and the subsequent GUI screens discussed below with respect to FIGS. 11A-11B. The compartment will then be automatically toggled to have an “assigned” value (as do all of the exemplary compartments in FIG. 9B). The “live” state can be used to indicate that the devices within a particular compartment are up and running and that the provisioning system 31 should recognize them as such in order to provide other services, e.g., monitoring.

Network engineers will also find it useful to be able to manage the numerous virtual local area networks (VLANs) which are provisioned, monitored and managed by provisioning system 31. As will be appreciated by those skilled in the art, VLANs are groups of devices on one or more different (physical) LANs that are configured so that they can communicate as if they were attached to the same physical LAN segment. VLANs provide certain advantages for customer web site hosting infrastructures as compared with LANs, e.g., avoiding latency problems associated with operating across a number of routers, but also require additional configuration to create the virtual association. For one infrastructure, such configuration may or may not be difficult to keep track of. However, as the present invention contemplates operation within an automated provisioning system wherein hundreds or thousands of different infrastructures are provisioned, monitored and managed, easy tools for VLAN management become very important for network engineers.

Accordingly, exemplary embodiments of the present invention provide extensive GUI functionality for managing VLANs. Actuating link 68 in FIG. 6, leads the user first to the exemplary GUI screen of FIG. 10A, wherein the user can opt to view VLANs based on their association with a particular data center or a particular customer. If the user selects VLAN management by customer, he or she can (optionally) be presented with a data center filter 100 (FIG. 10B) if the selected customer's infrastructure spans multiple data centers. These features permit network engineers to view network topology for entire data centers or for customers.

In this example, having selected a particular customer's VLANs to be managed, the user is then presented with a GUI that provides information associated with that customer's VLANs, e.g., as depicted in FIGS. 10C and 10D. Therein, FIG. 10C illustrates the top portion of the GUI display, while FIG. 10D shows the bottom portion of the same screen. Therein, the GUI 102 identifies each VLAN by its name, a pool name, a description, a pool type, a sub-type and a subnet. The description and pool name fields provide areas within which the network engineers or other operators of provisioning system 31 can enter descriptive information for each VLAN. The pool type field can take values such as “console”, “server”, “public” and “transit” which generally characterize the attributes of a particular VLAN. The sub-type can be used to further characterize the VLAN based on its role within a customer's infrastructure. For example, a customer may have two identical VLANs, one of which is used for production and the other of which is used for staging, within its hosted infrastructure. The subnet field identifies the IP space associated with each VLAN.

In addition to providing a significant amount of VLAN information, this GUI screen 102 also permits the user to perform various actions, both globally and individually, with respect to the customer's VLANs. For example, each VLAN can be viewed, edited or (not shown in FIGS. 10C and 10D) deleted. Viewing a particular VLAN provides an even greater amount of detail regarding the specific characteristics of a particular customer VLAN as depicted in FIG. 10E. Among other things, this GUI screen 104 provides the complete breakdown of IP address information for a particular VLAN, i.e., each individual address' hostname and status. This level of detail may be used by, for example, network engineers to determine the next available IP address that is available for new devices to be added to a customer's infrastructure.

Each individual VLAN record can also be edited from GUI screen 102, an example of which is provided as FIG. 10F. In addition to being able to edit the VLAN name, pool name and description of the VLAN from GUI screen 106, the user can also automate the generation of hostnames and DHCP (an acronym which stands for “Dynamic Host Configuration Protocol”) from this portion of GUIs according to the present invention. This facilitates change of the VLAN by network operators who, for example, wish to allocate additional IP addresses for new devices to be connected to the VLAN. Taking the VLAN whose characteristics are depicted in FIG. 10E as an example, a network operator can automatically generate new hostnames for available IP addresses XXX. 161-XXX. 167 that have not yet been assigned hostnames using the “generate” button in screen 106 for that VLAN. This feature can save network engineers significant time in adding new devices to a particular VLAN. As with other GUI embodiments according to the present invention, information changed or added using GUI screen 106 is also changed in the data model. Likewise, IP address space can be added to a VLAN from GUI screen 106 for devices which will request an IP address using DHCP. For example, when new device is plugged into the infrastructure that uses DHCP to request its network configuration from a DHCP server (not shown), the DHCP server will select an IP address that has been allocated as DHCP for a particular VLAN.

Returning to FIG. 10D, the bottom of GUI screen 102 also includes two GUI elements, in this example buttons, for adding new VLANs and adding a new data center for a particular customer. The user can add a new VLAN by actuating button 108, which results in a GUI screen such as that depicted in FIG. 10G being displayed on the user's monitor. Therein, the user can input all of the VLAN information which is useful for capture in the data model, as previously described with respect to FIGS. 10C and 10D. The user can also actuate the button 110 to add a new data center for a customer, e.g., if a customer wishes to move its infrastructure from one data center to another or if the customer wants to provide redundant infrastructure within different data centers, and then populate that new data center with new VLANs.

Returning to FIG. 6, the next link which is available for a user to manage network information is the “Assign Compartment” link 70. Actuating this link provides the user with the data center selection screen (FIG. 11A), from which the user is able to assign a compartment that has already been flagged as built and ready to assign to a customer. This can be accomplished by, for example, providing a GUI screen 120 in FIG. 11B which includes a list box that lists the available compartments within that data center and a list box which lists the available customers. The user can select one of each (as well as, optionally a sub-type for the compartment being assigned, e.g., production, staging, etc.) and then actuate the assign button 122.

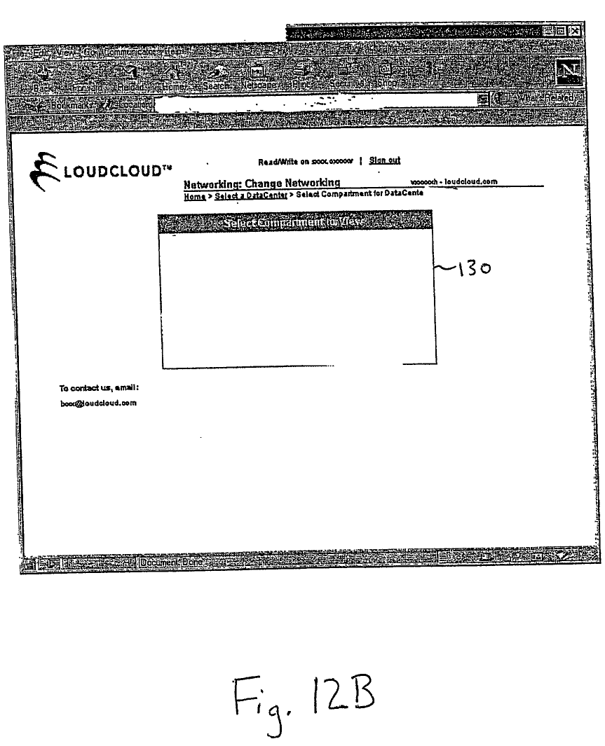

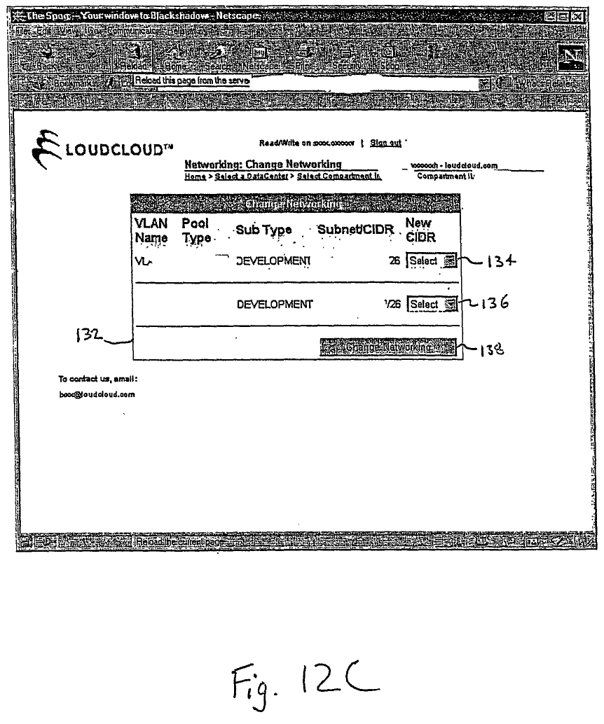

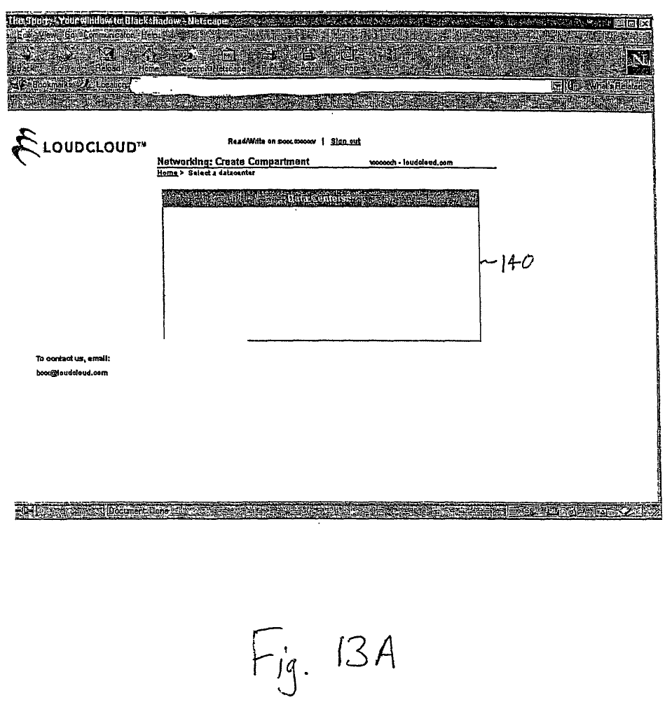

In the course of adapting the networking within the various customer infrastructures being handled by the provisioning system 31, it may be necessary to change the IP space which has been allocated to a particular VLAN. In particular, a VLAN may need more IP addresses than were originally allocated to it during the creation of the VLAN within the data model. This can be accomplished, according to exemplary embodiments of the present invention, by actuating the “Change CIDRs on VLANs” link 72 in FIG. 6. Again, the user can be prompted to select a data center for VLAN management as indicated in FIG. 12A. Then, the user can select the particular compartment within which it is desired to change the IP space of a VLAN using GUI screen 130 of FIG. 12B. This provides the user with, for example, the GUI screen 132 of FIG. 12C wherein a new CIDR (an acronym that stands for “Classless Inter-Domain Routing”) can be selected using GUI elements 134, 136. As will be appreciated by those skilled in the art, a CIDR address includes the standard 32-bit IP address as well as an indicator of how many of those bits constitute the network prefix. For example, in the CIDR address “308.14.02.64/26”, the “/26” indicates that the first 26 bits in the address are used to uniquely identify the network, with the remaining bits being used to identify the host. Thus a CIDR block prefix of “/27” provides 32 host addresses, “/26” provides 64 host addresses. . . , “/13” provides 524,288 host addresses, etc. Accordingly, the GUI elements 134, 136 can be configured as drop down boxes which permit a user to change the CIDR block prefix for a particular VLAN, e.g., from “/26” in FIG. 12C to “/25” to increase the number of devices which can be connected to that VLAN. The selection can then be implemented by actuating the change networking button 138, which change in IP address space is also reflected in a modification of the data model. Those skilled in the art will appreciate that this portion of GUIs according to the present invention permits network engineers to reconfigure the IP space assigned to a particular customer in a fast and efficient manner.

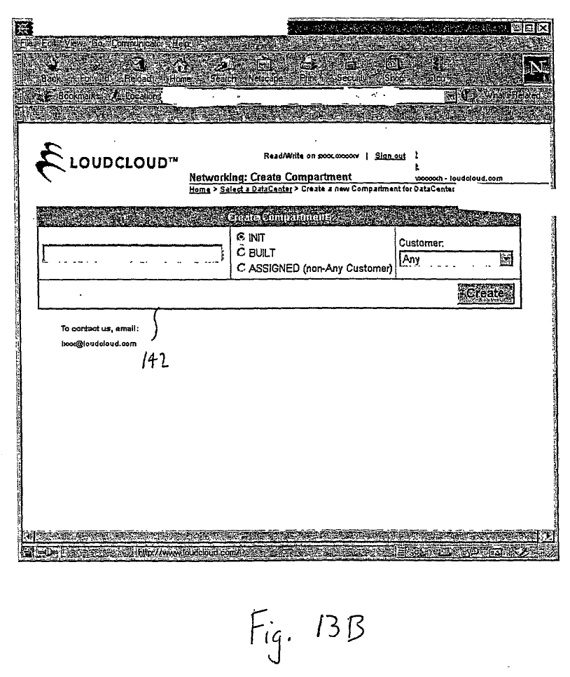

Networking GUIs according to the present invention also provide the capability to create the compartments. As mentioned previously, compartments are one technique whereby provisioning systems according to the present invention can segregate different customer infrastructures managed thereby. Actuating link 74 yields GUI screen 140 of FIG. 13A which, once again, permits the user to select a data center for compartment creation. Of course, data center selection filters would be unnecessary in embodiments of the present invention wherein GUIs were used to coordinate the activities of a single data center. Selection of a data center from FIG. 13A leads to the GUI screen 142, wherein the user can input the compartment name, the initial compartment value (described above) and a customer (if any) to be associated with this compartment.

From the foregoing, it will be apparent to those skilled in the art that graphical user interfaces according to the present invention provide an easy and speedy mechanism for operators of automated provisioning systems to access the multitude of data associated with the large number of devices being serviced by the system. These graphical user interfaces also provide a powerful tool for uniform, yet flexible, network configuration at a number of different levels, e.g., data center, compartment, customer, and VLAN, for a single device or across multiple devices.

It will be appreciated by those of ordinary skill in the art that the present invention can be embodied in other forms without departing from the spirit or essential characteristics thereof. For instance, while an exemplary embodiment of the invention has been described in the context of provisioning web site servers in a data center, it will be appreciated that the principles underlying the invention can be applied in any environment where computing devices need to be configured and/or updated on a relatively large scale. The foregoing description is therefore considered to be illustrative, and not restrictive. The scope of the invention is indicated by the following claims, and all changes that come within the meaning and range of equivalents are therefore intended to be embraced therein.

What is claimed is:

1. A graphical user interface for network configuration of a plurality of devices, said graphical user interface comprising:
a first user interface element actuable to access a first portion of said graphical user interface, which first portion displays information associated with a plurality of virtual local area networks (VLANs) associated with said plurality of devices.

2. The graphical user interface of claim 1, wherein said first user interface element is a link which is actuable via a pointing device and a cursor displayed on said graphical user interface.

3. The graphical user interface of claim 1, wherein said first portion of said graphical user interface includes a screen wherein a user can select from a plurality of data centers and a plurality of customers to access said information associated with said plurality of devices that correspond to said customer.

4. The graphical user interface of claim 1, wherein said first portion includes, as said information associated with said plurality of VLANs, a plurality of VLAN names.

5. The graphical user interface of claim 4, wherein each of said plurality of VLAN names is linked to a second portion of said graphical user interface, which second portion displays a status of each of a plurality of IP addresses associated with a selected VLAN.

6. The graphical user interface of claim 1, wherein said first portion includes, as said information associated with said plurality of VLANs, a plurality of compartment names that each identify a compartment within which a corresponding VLAN is disposed.

7. The graphical user interface of claim 6, wherein each of said plurality of compartment names is linked to a second portion of said graphical user interface, which second portion displays all of the VLANs associated with a selected compartment.

8. The graphical user interface of claim 1, wherein said first portion includes, as said information associated with said plurality of VLANs, a plurality of description fields, each of which provides a textual description of a corresponding VLAN.

9. The graphical user interface of claim 1, wherein said first portion includes, as said information associated with said plurality of VLANs, a plurality of type fields, each of which identifies a type of a corresponding VLAN.

10. The graphical user interface of claim 9, wherein said type field can include a value of one of: server, public, embryo, console.

11. The graphical user interface of claim 1, wherein said first portion includes, as said information associated with said plurality of VLANs, a plurality of status fields, each of which identifies a status of a corresponding VLAN.

12. The graphical user interface of claim 1, wherein said first portion includes, as said information associated with said plurality of VLANs, a plurality of subnet fields, each of which identifies an internet protocol (IP) address space assigned to a corresponding VLAN.

13. The graphical user interface of claim 12, wherein each of said subnet fields contain IP address range values expressed using a classless inter-domain routing (CIDR) protocol.

14. The graphical user interface of claim 1, wherein said first portion includes, as said information associated with said plurality of VLANs, a plurality of domain fields, each of which indicates a broadcast domain associated with a corresponding VLAN.

15. The graphical user interface of claim 1, wherein said first portion includes, as said information associated with said plurality of VLANs, a list of all of the VLANs located in a particular compartment.

16. The graphical user interface of claim 1, wherein said first portion includes, as said information associated with said plurality of VLANs, a plurality of sub-type fields, each of which defines a role of a corresponding VLAN within a customer's infrastructure.

17. The graphical user interface of claim 1, wherein said graphical user interface further comprises:
a second user interface element actuable to view additional information associated with a selected VLAN.

18. The graphical user interface of claim 17, wherein said additional information includes a status of each IP address assigned to said selected VLAN.

19. The graphical user interface of claim 17, wherein said additional information includes a hostname associated with each IP address assigned to said selected VLAN.

20. The graphical user interface of claim 1, wherein said graphical user interface further comprises:
a second user interface element actuable to edit information associated with a selected VLAN.

21. The graphical user interface of claim 20, wherein actuation of said second user interface elements results in an edit screen being displayed for said selected VLAN, wherein a user can enter at least one of a VLAN name, a pool name and a description.

22. The graphical user interface of claim 1, wherein said first portion includes, as said information associated with said plurality of VLANs, a mechanism for generating at least one hostname for a selected VLAN.

23. The graphical user interface of claim 22, wherein said mechanism is actuable to generate said at least one hostname for an unassigned IP address associated with said selected VLAN.

24. The graphical user interface of claim 1, wherein said first portion includes, as said information associated with said plurality of VLANs, a mechanism for generating at least one dynamic host configuration protocol (DHCP) reservation for an available IP address associated with said selected VLAN.

25. The graphical user interface of claim 1, wherein said first portion includes, as said information associated with said plurality of VLANs, a mechanism for generating a plurality of hostnames for a selected VLAN.

26. The graphical user interface of claim 1, wherein said first portion includes, as said information associated with said plurality of VLANs, a GUI element actuable to add another VLAN to a customer's infrastructure.
